(19) United States
(12) Patent Application Publication
(10) Pub. No.: US 2015/0052187 A1
(43) Pub. Date: Feb. 19, 2015

(54) SYSTEMS AND METHODS FOR ACCESSING VIA A MOBILE COMPUTING DEVICE IN REAL-TIME OR SUBSTANTIALLY REAL-TIME, CLIENT RELATIONSHIP MANAGEMENT INFORMATION

(71) Applicant: Applied Systems, Inc., University Park, IL (US)

(72) Inventors: Warren Schultz, Manhattan, IL (US); Thomas J. Ives, Londonderry, VT (US); Timothy Woods, Phoenix, AZ (US)

(73) Assignee: Applied Systems, Inc., University Park, IL (US)

(21) Appl. No.: 13/965,571

(22) Filed: Aug. 13, 2013

(51) Int. Cl. H04L 29/06

(52) U.S. Cl. CPC H04L 67/42
USPC 709/203

(57) ABSTRACT

Systems and methods are provided for accessing, with a mobile device in real-time or substantially real-time, CRM information. The CRM information may include name, address, phone number, alternate phone number, facsimile number, email address, relationships, activities, insurance policies, insurance certificates, vehicles owned or leased, associated drivers of said vehicles, equipment owned or leased, property owned, watercraft owned or leased, other insurance schedules, endorsements, risk analysis and/or policy declaration pages.

### FIELD OF THE INVENTION

The invention relates generally to Customer Relationship Management (“CRM”) software and more particularly to a mobile device for providing access to real-time or substantially real-time CRM information.

### BACKGROUND OF THE INVENTION

CRM software is essentially software that helps an enterprise manage customer information/relationships. For example, an enterprise might have a database populated by customer information and information about various products/services offered by the enterprise in sufficient detail so that management, Customer Service Representative (“CSR”), and often-times the customer, can access the information and make informed decisions regarding the current and/or future relationship. Typically a producer/salesperson, while in the office, will download information about clients (referred to throughout as client or customer interchangeably) and/or prospective clients (“Prospects”) that he/she intends to visit. Then that producer leaves the office with just that information. If a new lead or appointment is presented, the producer must return to the office to download current information related to that new lead or appointment.

Productivity is more critical than ever for producers. To increase the likelihood of successfully transforming sales opportunities into revenue or to provide quality service, producers need to be able to access the information from the CRM software, regardless of their location. They also need up-to-date information to ensure that they do not appear foolish and/or uninformed to the customer/potential customer.

In view of the foregoing, it would be advantageous to provide an improved system which provides access in real-time, or substantially real-time, to CRM information. It would also be advantageous to provide such a system that enables a producer to access such information on a mobile device.

### BRIEF SUMMARY OF THE INVENTION

Many advantages of the invention will be determined and are attained by the invention, which in a broad sense provides system for providing access to real-time or substantially real-time CRM information on a mobile device.

A system is provided for accessing, in real-time or substantially-real-time, via a communications network, information associated and/or related to a client. The system includes a server and a database, stored on the server, which is configured to store information associated with a client and to store updated information associated with the client. The system includes an extraction utility in selective communication with the server and configured to retrieve at least some of the stored information and provide the retrieved information to a database stored on another server. The other server is accessible via the communications network. The system also includes a mobile computing device configured to selectively communicate with the other server via the communications network and receive and display at least a portion of the retrieved information stored on the other server. The mobile device is further configured to upload data to the server for storage in the database, and to receive, in real-time, at least a portion of the updated information associated with the client.

A method is also provided for accessing, in real-time or substantially-real-time, via a communications network, information related to a client. The method includes storing information associated with a client in a database and subsequently storing additional information associated with the client in the database. The database is accessible via the communications network. An extraction utility selectively accesses the database, retrieves at least some of the information stored in the database and forwards the retrieved information to another server. A mobile device selectively communicates with the other server and retrieves and displays at least a portion of the retrieved information. The server receives from the mobile device activity information and stores the activity information in the database. The extraction utility, subsequent to selectively accessing the database accesses the database again, retrieves at least a portion of the additional information and forwards the retrieved additional information to the other server. The mobile device selectively communicates with the other server again and retrieves and displays at least a portion of the retrieved additional information.

A mobile computing device is provided, which is configured to receive, in real-time or substantially-real-time, and display, information associated with a client. The mobile device includes a computer program stored and running on the mobile computing device. The computer program enables the mobile computing device to selectively communicate with a remote server via a communications network to retrieve and display at least a portion of the information associated with the client and to subsequently retrieve, in real-time, and display, updated information associated with the client. The information associated with the client includes name, address, phone number, alternate phone number, facsimile number, email address, relationships, activities, insurance policies, insurance certificates, vehicles owned or leased, associated drivers of said vehicles, equipment owned or leased, property owned, watercraft owned or leased, other insurance schedules, endorsements, risk analysis and/or policy declaration pages. The computer program further enables the mobile computing device to selectively communicate with another remote server via the communications device to upload information associated with a user of the mobile device for real-time storage of the uploaded information.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram of a system in accordance with embodiments of the invention;

FIG. 2 is a block diagram of an alternate embodiment of the system of FIG. 1 in accordance with embodiments of the invention;

FIG. 3 is a flowchart illustrating operation of an apparatus in accordance with one or more embodiments of the invention;

FIG. 4 is a sample display on a mobile device illustrating a list of accounts in accordance with one or more embodiments of the invention; and,

FIG. 5 is a sample display on the mobile device of FIG. 4 illustrating information related to a single account from FIG. 4 in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

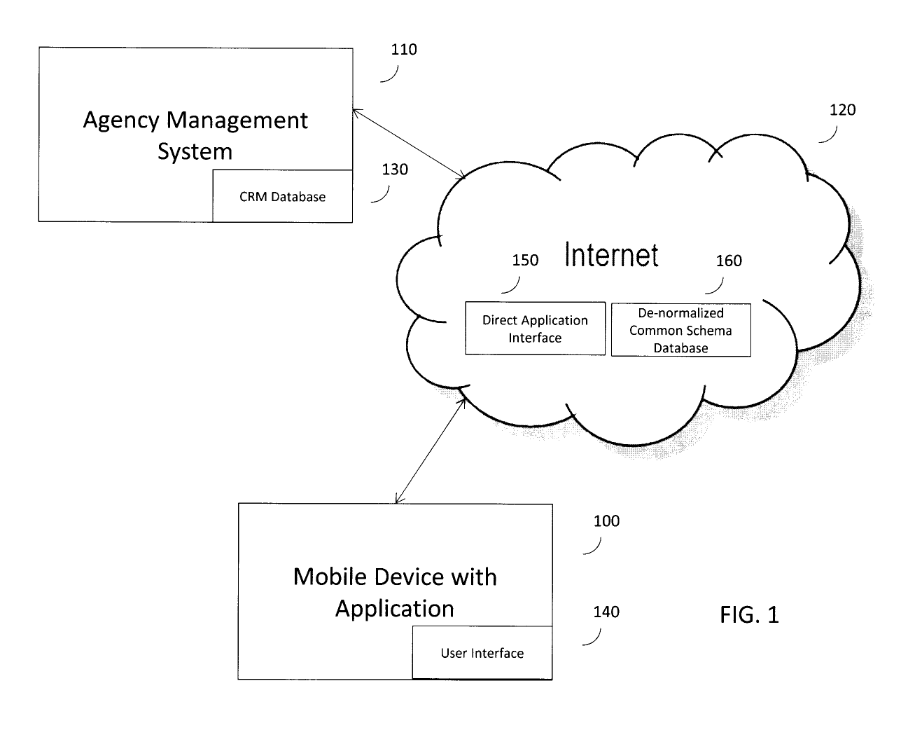

Referring to the drawings in detail wherein like reference numerals identify like elements throughout the various figures, there is illustrated in FIGS. 1-5 a systems for accessing, via a mobile device, CRM information in real-time or substantially real time.

The following description is be limited to the insurance industry. The principles and operations of the invention may be better understood with reference to the drawings and the accompanying description.

Referring to FIG. 1, in an exemplary embodiment of the invention, the system includes a mobile device with an installed application (“device”) 100 and an interface 140 configured for use by producers who wish to review CRM information. The system also includes a conventional Agency Management Systems (“AMS”) 110 which includes CRM database 130 and a direct application interface 150 for direct access to the AMS. Some non-limiting examples of direct application interfaces 150 are the Epic SDK™ and TAM ConneXion™ programs provided by Applied Systems, Inc. The CRM database 130 may be accessed and modified by certain users of the AMS systems. The AMS may also include a working copy of the CRM database to prevent corruption of the data from the original database 130 although the system could operate without a copy and still fall within a scope of the invention. An extraction utility (not illustrated) such as the CSR24 extractor from Applied Systems, Inc., although other conventional extractor utilities may be employed, queries the working copy of database 130 and extracts a subset of the replicated data. The extraction can run once a day, multiple times a day or less frequently depending on the environment and circumstances. The extraction utility sends the extracted data to a de-normalized common schema database 160 that is housed in a hosted environment accessible via the Internet 120. The de-normalized database 160 may be accessed and modified by users of the host website. When mobile device 100 requires data it either accesses the common schema database 160 using web based calls or it accesses the AMS 110 via direct interface connectivity depending on the information required (discussed further below). For example, mobile device could access AMS 110 via an interface such as, but not limited to, the Epic SDK™ and/or TAM ConneXion™ direct interface. Those skilled in the art will recognize that there are various other conventional ways in which mobile device 100 can access database 160 and that any of these methods may be employed without departing from a scope of the invention. Among such ways, although not exhaustive, are dial-up connection, a secure or unsecured connection, virtual private network (VPN), cable or satellite connection, a local area network (“LAN”), any other suitable wired, wireless, or optical connection, or a combination thereof. Those skilled in the art will also recognize that while only one mobile device 100 and one AMS 110 have been illustrated, this was only done to avoid overcomplicating the drawing and the system is not so limited. There could be multiple devices 100. The AMS 110 could be realized on a single server, multiple servers, multiple networked devices etc and could be a single AMS or multiple AMSs. Additionally, databases 130 and 160 may each be a single database or multiple databases and still fall within a scope of the invention.

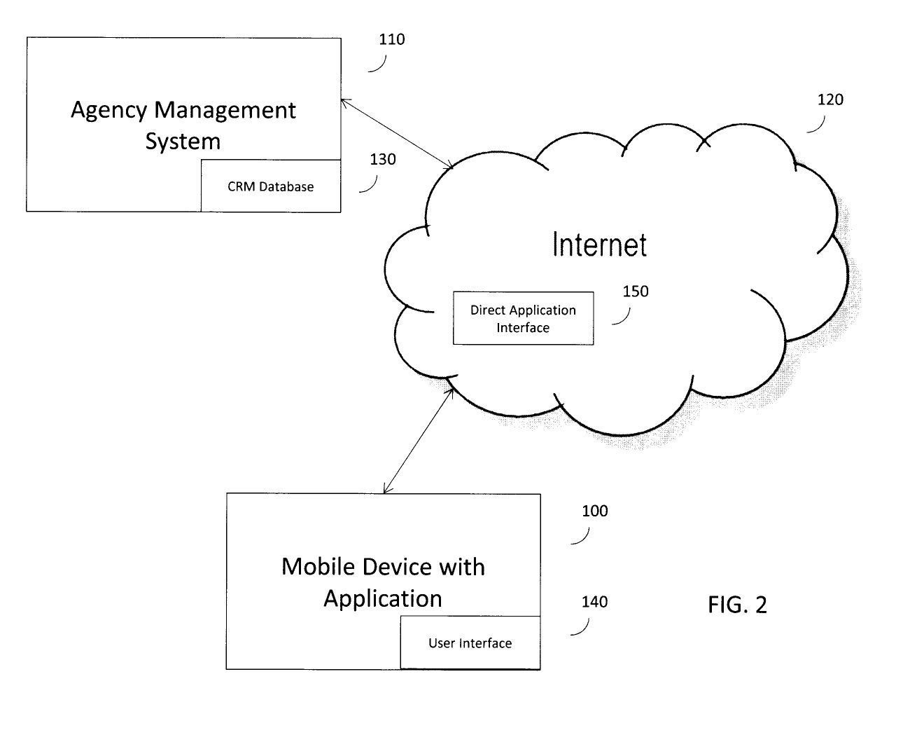

Referring to FIG. 2, in an exemplary alternate embodiment of the embodiment of FIG. 1, the system includes a mobile device with an installed application (“device”) 100 and an interface 140 configured for use by producers who wish to review CRM information. The system also includes a conventional Agency Management Systems (“AMS”) 110 which includes CRM database 130 and a direct application interface 150 for direct access to the AMS. Some non-limiting examples of direct application interfaces 150 are the Epic SDK™ and TAM ConneXion™ programs provided by Applied Systems, Inc. The CRM database 130 may be accessed and modified by certain users of the AMS systems. The AMS may also include a working copy of the CRM database 130 to prevent corruption of the data from the original database 130 although the system could operate without a copy and still fall within a scope of the invention. When mobile device 100 requires data it accesses the AMS 110 via direct interface connectivity. For example, mobile device could access AMS 110 via an interface such as, but not limited to, the Epic SDK™ and/or TAM ConneXion™ direct interface. Those skilled in the art will recognize that there are various other conventional ways in which o mobile device 100 can access AMS 110 and that any of these methods may be employed without departing from a scope of the invention. Among such ways, although not exhaustive, are dial-up connection, a secure or unsecured connection, VPN, cable or satellite connection, a LAN, any other suitable wired, wireless, or optical connection, or a combination thereof.

Database 130 may store customer/potential customer information, policy information, endorsements, policy declarations pages, other documents related to customer(s)/prospect(s). Some of the functionality on mobile device 100 may not require access to the databases, but instead relies on information already downloaded and programming already stored on the mobile device 100. For example, a feature offered on mobile device 100 is “on-the-go” which employs a mapping program, such as Google Maps™, to indicate points of interest that are geographically near to the mobile device. The program for accessing the maps would be local to the mobile device and not require communications with either database.

Device 100 includes a user interface 140 and may include any suitable computing equipment for accessing and interacting with database 160 (FIG. 1) over Internet 120 or some other communications network 120 (e.g. television network, cable network, etc.) and interacting directly with AMS 110 (FIG. 1 and/or FIG. 2). The following description will be limited to an Apple iPad™ however, those skilled in the art will recognize that device 100 may be a laptop computer, tablet computer, telephone (e.g., smartphone), personal digital assistant (“PDA”), Android™ device, BlackBerry™ device, or any other suitable mobile computing device. Since different devices may be employed by the producer, reference to any one type of device will be understood to include any or all types of suitable computing equipment.

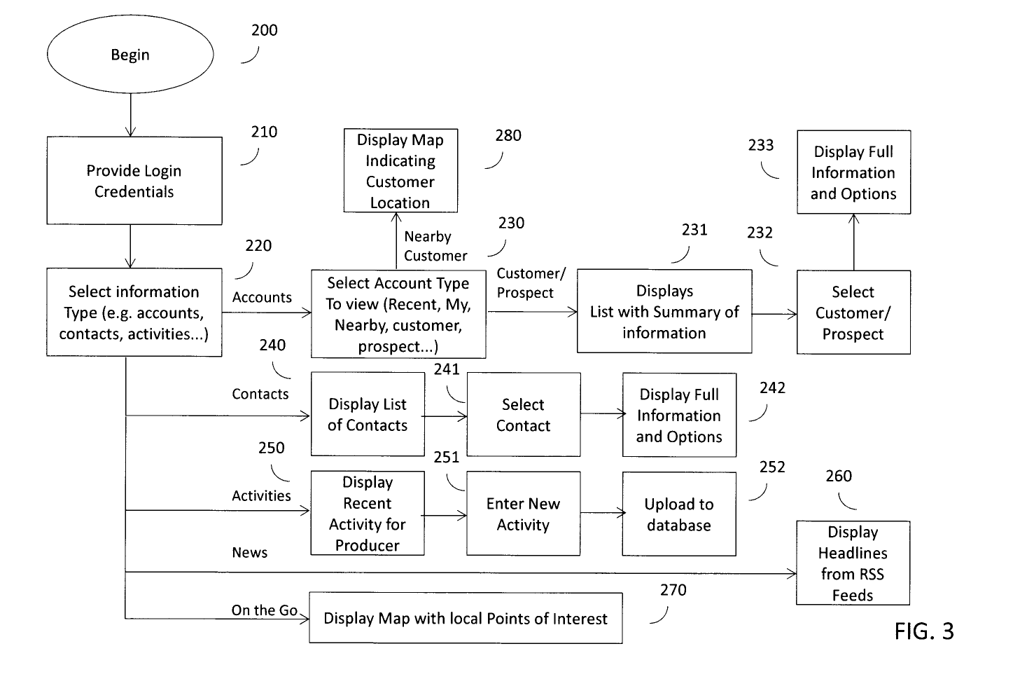

In operation, as illustrated by the general flow chart of FIG. 3, the system is configured to enable a producer who is away from the office to access real time information or substantially-real time information about a client and/or potential client. By real-time this description refers to being able to access information within 15 minutes of it being entered into the database and substantially real-time refers to information that is accessible within 24 hours of the information being entered into the database. Operation begins at step 200 which in a preferred embodiment is the producer selecting the application (“the “app”) for display on device 100. The producer opens the app and the user interface 140 displays a login screen. The producer enters login information 210 such as company ID, Producer ID and password or the information could be defaulted to a particular company ID and producer ID. Additional or different information could be employed for logging in or, while not preferred, the app could be configured without a login being required. Once the login information is accepted, a display similar to that of FIG. 3 is displayed on user interface 140. Those skilled in the art will recognize that the arrangement of information in FIG. 3 is a design choice and other arrangements could be employed without departing from a scope of the invention. In a preferred embodiment, the default view, when the app is first opened, is recent accounts 311, listing both 315 customers 314 and prospects 315. The interface 140 also displays various options such as accounts 310, contacts 320, activities 330, news 340, on the go 350 and settings 360. This is a design choice and the default could be one of the other possible selections, a generic page or it could be configurable by the producer.

As illustrated by the exemplary display of FIG. 3, interface 140 provides various options 220 such as accounts 310, contacts 320, recent activity related to one or more accounts (“activities”) 330, news 340, a map of nearby locations of interest (“on the go”) 350 or settings 360. It also provides the option of viewing recent accounts 311, accounts for which the producer is responsible (e.g. “my accounts”) 312, and a map of accounts within a certain distance of device's 100 present location (“nearby accounts”) 313. It also provides the option of drilling down the accounts by customer (“insured”) 314, prospective customers (“prospects”) 314 or a combination of both 316. Further, the producer may be provided with a search option 317 for searching through accounts. Those skilled in the art will recognize that the search function could be configured to search other information without departing from a scope of the invention. For example, it could provide the ability to search the Internet, and/or it could provide the ability to search through any or all of the above identified options without departing from a scope of the invention.

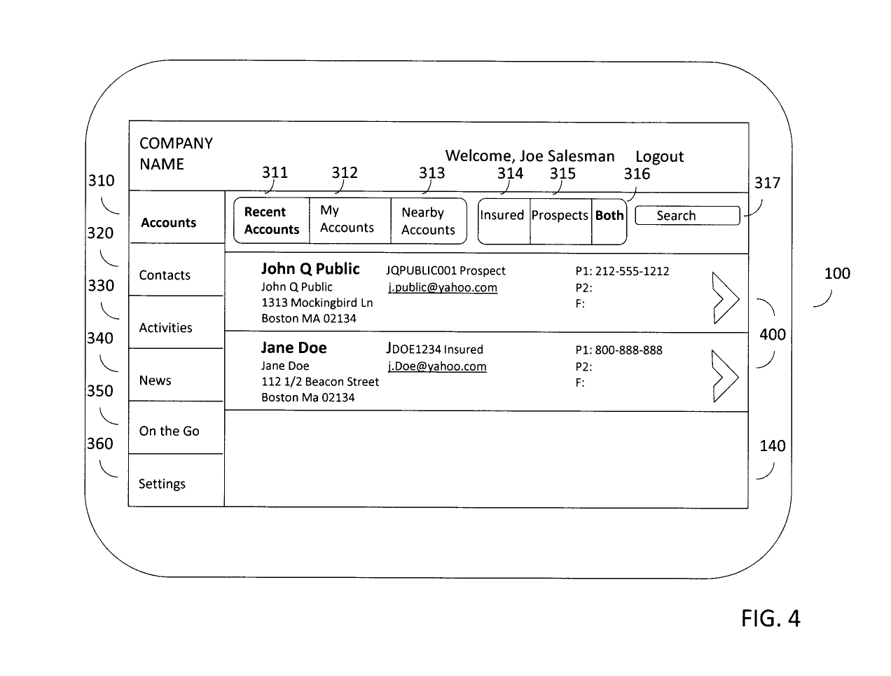

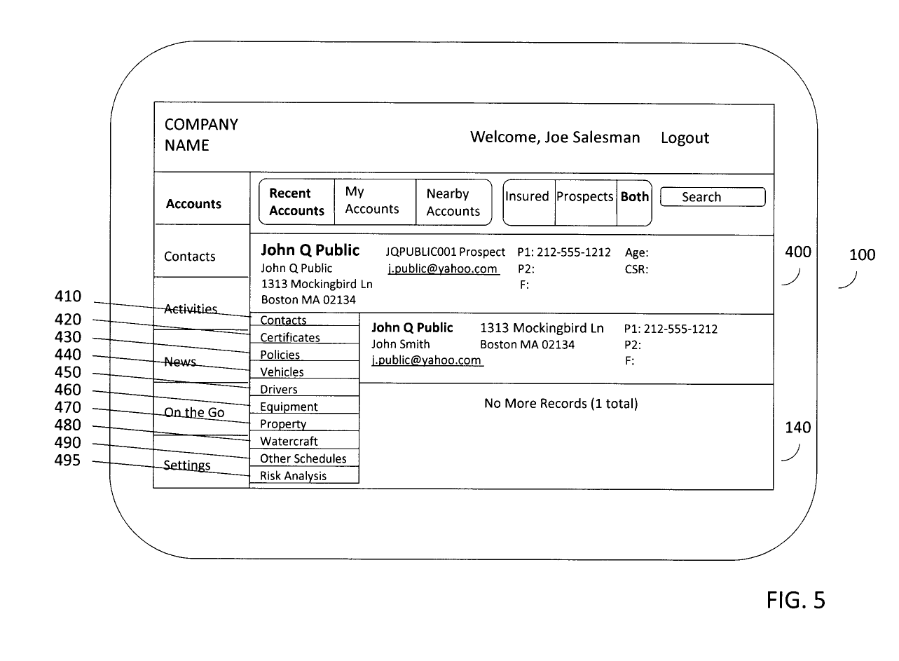

Accounts: When the producer selects one of the accounts, e.g. John Q Public, device 100 retrieves the information from database 160 (FIG. 1) or database 130 (FIG. 2) or from the copy of database 130 via a web method call. Device 100 then displays a list of information related to that account and various other options from which the producer may select (e.g. Contacts 410, Certificates 420, Policies 430, Vehicles 440, Drivers 450, Equipment 460, Property 470, Watercraft 480, Other Schedules 490 and Risk Analysis 495) (See FIG. 4). FIG. 5 illustrates a non-limiting example of producer selecting the John Q Public account 400. As illustrated, the display defaults to contacts 410 related to the John Q Public account. In this instance, there are no additional people associated with the account. Thus the display only provides information related to Mr. Public (e.g. full name, address, phone number(s) fax number, age, account manager, policies owned, etc.), and a statement that there are “No More Records (1 total)”. Had there been additional people associated with the John Q Public account (e.g. wife, son, daughter, brother, etc.), information related to those people would be listed below Mr. Public's information and the total would change to reflect the number of records associated with the John Q Public account 400. As illustrated, the producer is provided with the following additional options related to Mr. Public's account: Contacts 410, Certificates 420, Policies 430, Vehicles 440, Drivers 450, Equipment 460, Property 470, Watercraft 480, Other Schedules 490 and Risk Analysis 495. Those skilled in the art will recognize that: the default need not be contacts, there could be fewer, more or different options than the ones listed, and the display of records could be arranged differently than as a top down scroll list without departing from a scope of the invention.

If the producer selects certificates 420, device 100 downloads the information from database 160 (FIG. 1) or database 130 (FIG. 2) or from the copy of database 130 and interface 140 displays a list of insurance certificates associated with the John Q Public account. If the producer selects Policies 430, device 100 downloads the information from database 160 (FIG. 1) or database 130 (FIG. 2) or from the copy of database 130 and interface 140 displays a list of insurance policies associated with the John Q Public account. If the producer selects Vehicles 440, Equipment 460, Property 470, or Watercraft 480, device 100 downloads the information from database 160 (FIG. 1) or database 130 (FIG. 2) or from the copy of database 130 and interface 140 respectively displays a list of insured vehicles, equipment, property or watercraft owned or leased by John Q Public. If the producer selects Drivers 450, device 100 downloads the information from database 160 (FIG. 1) or database 130 (FIG. 2) or from the copy of database 130 and interface 140 displays a list of drivers associated with the various insured vehicles John Q Public. If the producer selects other schedules 490, device 100 downloads the information from database 160 (FIG. 1) or database 130 (FIG. 2) or from the copy of database 130, and interface 140 displays a list of insurance schedules associated with the John Q Public account. Finally, if the producer selects Risk Analysis 495, device 100 enables the producer to perform a conventional risk analysis. The producer is provided access to risk information on various types of commercial, business and/or personal risks, allowing them a unique way to determine the needs of an insured or prospect. The risk information is presented via a series of questions and possible answers, empowering the producer to interview the insured or prospect in ways on which they may not have been previously educated. This enables the producer to sell the correct insurance and at the correct level of protection. The risk information is dynamically generated at runtime based off of the type of business and risks they have selected. When the risk survey has been completed, it can be distributed in three ways (1) as an attachment on an activity which allows the producer to directly integrate his work into the AMS 110 where it can be further processed, (2) as an attachment in an email where further processing can take place, (3) saved to the local device 100 where it can be viewed, modified, and used in comparisons from one time period to another time period, or from one account to another account. The various fields for the risk analysis program may be auto-populated from information already downloaded to the mobile device, or they may be populated manually.

Contacts: When the producer selects contacts 320 from the main menu, device 100 retrieves the producer's contact information from the database 160 (FIG. 1) or database 130 (FIG. 2) or from the copy of database 130 and interface 140 displays the information in a list.

Activities: When the producer selects activities 330 from the main menu, the producer is provided the ability to access 2 different types of activity information; (1) activities of which they are the owner, (2) activities associated with an account. Activity information is gathered from the AMS 110 using a web method that provides direct application interfacing. The direct application interface communicates with the AMS 110 by querying the data needed, sending the data back through the web method to device 100. The producer can also add an activity. When an activity is added, data is sent through the web method via the direct application interface 150 and the activity is added to the agency management system.

News: The news option 340 provides headlines and links from industry related periodicals and provides the ability to include additional RSS feeds for personalization.

On The Go: On the go 350 is a mapping function that displays a map with locations of possible interest and locations of clients and potential clients all within proximity of device 100. Within proximity means within a certain preset distance or may mean within a distance that may be set by the producer.

Settings: The settings option 360 enables the producer to change login information, and add or delete RSS feeds for the news option. Those skilled in the art will recognize that fewer, additional or different settings could be modifiable under setting option 360 without departing from a scope of the invention. For example, the list view for the various client/prospect options could be modified for different displays configurations, etc.

Thus it is seen that systems and methods are provided for accessing CRM information in real-time or substantially real-time via a mobile device. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, the system is described as being set up as a program running on a mobile computer that communicates over the Internet, with a database. However, the system could also function with multiple computers and/or multiple agency management systems configured to perform the various operations and/or communications could take place via a network other than the Internet. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system for accessing, in real-time or substantially-real-time, via a communications network, information related to a client, the system comprising:
a server;
a database stored on said server and configured to store information associated with a client and to store updated information associated with said client;
an extraction utility in selective communication with said server and configured to retrieve at least some of said stored information and provide said retrieved information to a database stored on another server; said another server being accessible via said communications network; and,
a mobile computing device configured to selectively communicate with said another server via said communications network and receive and display at least a portion of said retrieved information stored on said another server;
wherein said mobile device is further configured to upload data to said server for storage in said database; and,
wherein said mobile device is configured to receive, in real-time, at least a portion of said updated information associated with said client.

2. The system according to claim 1 wherein said information associated with said client includes said information selected from at least one member of the group consisting of name, address, phone number, alternate phone number, facsimile number, email address, relationships, activities, insurance policies, insurance certificates, vehicles owned or leased, associated drivers of said vehicles, equipment owned or leased, property owned, watercraft owned or leased, other insurance schedules, endorsements, risk analysis and policy declaration pages.

3. The system according to claim 1 wherein said mobile device is configured to receive, in substantially real-time, updated information associated with said client.

4. The system according to claim 1 wherein said mobile device is further configured to display a map showing a location of said client relative to a location of said mobile device.

5. The system according to claim 1 wherein said mobile device is configured to display a map showing a location of a potential point of interest relative to a location of said mobile device.

6. The system according to claim 1 wherein said mobile device is configured to display news from at least one industry periodical.

7. The system according to claim 1 wherein said client is a prospective client.

8. The system according to claim 1 wherein said database is further configured to store information associated with a prospective client; and,
wherein said mobile device is configured to display at least some of said information associated with said client together with at least some of said information associated with said prospective client.

9. A method for accessing, in real-time or substantially-real-time, via a communications network, information related to a client, the method comprising:
storing information associated with a client in a database and subsequently storing additional information associated with said client in said database, wherein said database is accessible via said communications network;
an extraction utility selectively accessing said database;
said extraction utility retrieving at least some of the information stored in said database and forwarding said retrieved information to another server;
a mobile device selectively communicating with said another server and retrieving and displaying at least a portion of said retrieved information;
said server receiving from said mobile device activity information and storing said activity information in said database; and,
said extraction utility, subsequent to selectively accessing said database accessing said database again and retrieving at least a portion of the additional information and forwarding said retrieved additional information to said another server; and, said mobile device selectively communicating with said another server again and retrieving and displaying at least a portion of said retrieved additional information.

10. The method according to claim 9 wherein said information associated with said client includes information selected from at least one member of the group consisting of name, address, phone number, alternate phone number, facsimile number, email address, relationships, activities, insurance policies, insurance certificates, vehicles owned or leased, associated drivers of said vehicles, equipment owned or leased, property owned, watercraft owned or leased, other insurance schedules, endorsements, risk analysis and policy declaration pages.

11. The method according to claim 9 wherein said information associated with a client further comprises information associated with a prospective client.

12. A mobile computing device configured to receive, in real-time or substantially-real-time, and display information associated with a client, said mobile device comprising:
a computer program stored and running on said mobile computing device, said computer program enabling said mobile computing device to selectively communicate with a remote server via a communications network to retrieve and display at least a portion of said information associated with said client and to subsequently retrieve, in real-time, and display updated information associated with said client;
wherein said information associated with said client includes information selected from at least one member of the group consisting of: name, address, phone number, alternate phone number, facsimile number, email address, relationships, activities, insurance policies, insurance certificates, vehicles owned or leased, associated drivers of said vehicles, equipment owned or leased, property owned, watercraft owned or leased, other insurance schedules, endorsements, risk analysis and policy declaration pages;
said computer program further enabling said mobile computing device to selectively communicate with another remote server via said communications device to upload information associated with a user of said mobile device for real-time storage of said uploaded information.

13. The mobile computing device according to claim 12 further configured to display a map showing a location of said client relative to a location of said mobile device.

14. The mobile device according to claim 12 further configured to display a map showing a location of a potential point of interest relative to a location of said mobile device.

15. The mobile device according to claim 12 further configured to display news from at least one industry periodical.

16. The mobile computing device according to claim 12 wherein said client is a prospective client.

17. The mobile computing device according to claim 16 wherein said mobile computing device is further configured to receive, in real-time or substantially-real-time, and display information associated with said prospective client.
